(19) United States
(12) Patent Application Publication
(10) Pub. No.: US 2024/0292856 A1
(43) Pub. Date: Sep. 5, 2024

(54) MANUFACTURING METHOD OF VEGETABLE LACTIC ACID BACTERIA FERMENTED ALMOND MILK

(71) Applicant: Armored Fresh. Inc, Seoul (KR)

(72) Inventors: Yong Kuk Park, Hwaseong-si (KR); Geunseo Yang, Seoul (KR)

(73) Assignee: Armored Fresh. Inc, Seoul (KR)

(21) Appl. No.: 18/250,803

(22) PCT Filed: Feb. 3, 2023
(86) PCT No.: PCT/KR2023/001603

§ 371 Date: Apr. 27, 2023

(30) Foreign Application Priority Data
Feb. 7, 2022 (KR) 10-2022-0015406
Apr. 14, 2022 (KR) 10-2022-0046379

(51) Int. Cl. A23C 11/10; A23J 3/14; A23L 2/38; A23L 25/00

(52) U.S. Cl. CPC A23C 11/106; A23J 3/14; A23L 2/382; A23L 25/00

(57) ABSTRACT

A manufacturing method of vegetable lactic acid bacteria fermented almond milk is provided, and the problem to be solved is to manufacture vegetable lactic acid bacteria fermented almond milk rich in taste and nutrients by blending mixed lactic acid bacteria strains to realize the rich aroma compound of cheese in the fermentation process of vegetable almond milk, unlike milk fermented milk, initial growth quickly controlling the fermentation process of the mixed strain to realize a rich taste, and using its metabolites.

Disclosed herein is a manufacturing method of vegetable lactic acid bacteria fermented almond milk including an almond milk protein enrichment step of adding almond protein to almond milk, an almond milk synbiotics mixing step of mixing synbiotics with the protein-enriched almond milk provided from the almond milk protein enrichment step, an almond milk lactic acid bacteria primary fermentation step in which vegetable mixed lactic acid bacteria strain is inoculated into the synbiotics almond milk provided from the almond milk synbiotics mixing step and primary fermented, and a secondary fermentation step of adding a vegetable almond fermentation starter to the primary fermented synbiotics almond milk provided from the primary cultivation step of the almond milk lactic acid bacteria, followed by secondary fermentation of the almond milk lactic acid bacteria, as an exemplary embodiment.

### TECHNICAL FIELD

An exemplary embodiment of the present invention relates to a manufacturing method of vegetable lactic acid bacteria fermented almond milk.

### BACKGROUND ART

Unlike milk fermentation, vegetable fermentation generally has a characteristic that the fermentation mechanism is slow or the fermentation does not proceed well in the process of fermentation by lactic acid bacteria. This is because there is no lactose, the source of carbohydrates that only milk has.

In addition, in fermenting with vegetable lactic acid bacteria derived from kimchi, rather than lactic acid bacteria commonly used in fermented milk, etc., the fermentation mechanism is very complicated and it is very difficult to produce fermented curd.

Almonds generally have a high fat content of about 52% per 100 grams. For this reason, when using a general almond juice method, problems such as coagulation and precipitation of sticky and juiced fat together with proteins, carbohydrates, or additives may occur due to the high fat content of almonds.

In addition, since almond fat goes rancid quickly, there is a problem that inherent rancid flavor in the product is likely to occur in the future.

As related art literature in association with the present invention, there are Patent Publication
No. 10-1164163 (Date of Patent: Jul. 3, 2012), Patent Application Publication
No. 10-2017-0137684 (Date of Publication: Dec. 13, 2017), Patent Application Publication
No. 10-2015-0132961 (Date of Publication: Nov. 27, 2015), Patent Publication
No. 10-0780030 (Date of Patent: Nov. 21, 2007).

### DETAILED DESCRIPTION OF THE INVENTION

### Technical Problem

An exemplary embodiment of the present invention provides a manufacturing method of vegetable lactic acid bacteria fermented almond milk rich in taste and nutrients by blending mixed lactic acid bacteria strains to realize the rich aroma compound of cheese in the fermentation process of vegetable almond milk, unlike milk fermented milk, controlling the fermentation process of the mixed strain to realize a rich taste, and using its metabolites.

### Means to Solve the Problem

manufacturing method of vegetable lactic acid bacteria fermented almond milk according to an exemplary embodiment of the present invention includes: almond milk protein enrichment step of adding almond protein to almond milk; almond milk synbiotics mixing step of mixing the synbiotics with the protein-enriched almond milk provided from the almond milk protein enrichment step; almond milk lactic acid bacteria primary fermentation step of firstly fermenting the synbiotics almond milk provided from the almond milk synbiotics mixing step by inoculating a vegetable mixed lactic acid strain; and a secondary fermentation step of almond milk lactic acid bacteria by adding a vegetable almond fermentation starter to the firstly fermented synbiotics almond milk provided from the first step of culturing the almond milk lactic acid bacteria for secondary fermentation.

In addition, prior to the almond milk protein enrichment step, it may further include an almond preparation step of washing the almonds to remove foreign substances from the almond hulls, performing soaking for 6 to 24 hours on the almonds from which the foreign substances are removed, and then removing the almond hulls by churning; and an almond milk production step of producing almond milk by squeezing the almonds prepared from the almond preparation step.

In addition, it may further include a cooling and packaging the vegetable lactic acid bacteria fermented almond milk step in which a rapid cooling process below 8° C. is performed in order to prevent post-cultivation of the vegetable lactic acid bacteria fermented almond milk provided from the secondary fermentation step of almond milk lactic acid bacteria, the process of preventing foreign substances from entering and removing carbides using a 50 to 100 mesh bag or SUS filter is performed when transporting rapidly cooled vegetable lactic acid bacteria fermented almond milk for packaging, the packaging process is performed after removing the iron foreign matter using a magnetic rod of 10,000 gauss or more, and weight inspection and X-ray inspection of packaged vegetable lactic acid bacteria fermented almond milk is performed.

In addition, it may further include a vegetable lactic acid bacteria fermented almond milk ripening step in which the packaged vegetable lactic acid bacteria fermented almond milk provided from the vegetable lactic acid bacteria fermented almond milk cooling and packaging step is aged between 0°° C. and 8° C. for 12 to 24 hours.

In addition, in the almond milk protein enrichment step, almond protein may be added to the almond milk at a ratio of 1:0.05 to 1:0.15 based on the weight of the almond milk.

In addition, in the almond milk synbiotics mixing step, glucose may be added to almond milk at a ratio of 1:0.005 to 1:0.015 by weight of almond milk, and oligosaccharide may be added at a ratio of 1:0.002 to 1:0.025 based on the weight of almond milk.

In addition, in the primary fermentation step of almond milk lactic acid bacteria, vegetable mixed lactic acid bacteria strains including Leuconostoc Citreum, Leuconostoc Kimchi and Lactic acid bacteria brevis are mixed with synbiotics almond milk, but the vegetable mixed lactic acid bacteria strains can be inoculated at a ratio of 1:00025 to 1:0.001 based on the weight of synbiotics almond milk.

In addition, in the primary fermentation step of almond milk lactic acid bacteria, the vegetable mixed lactic acid strain can be prepared by mixing Leuconostoc Citreum at a ratio of 1:0.25 to 0.55 based on the total ratio of vegetable mixed lactic acid bacteria strains, mixing Leuconostoc Kimchi at a ratio of 1:0.25 to 0.45 based on the total ratio of vegetable mixed lactic acid bacteria strains, and mixing Lactic acid bacteria brevis at a ratio of 1:0.25 to 0.42 based on the total ratio of vegetable mixed lactic acid bacteria strains.

In addition, in the primary fermentation step of almond milk lactic acid bacteria, sterilize the synbiotics almond milk at 84 “C to 86° C. for 30 to 120 seconds before mixing it with vegetable mixed lactic acid bacteria strains, inoculate the mixed vegetable lactic acid bacteria strain after cooling to 32° C. to 36° C., and primary fermentation may be carried out with synbiotics almond milk inoculated with vegetable mixed lactic acid bacteria strains at a temperature of 32° C. to 40° C. for 12 to 18 hours.

In addition, in the secondary fermentation step of almond milk lactic acid bacteria, after sterilizing synbiotics almond milk at 84° C. to 86” C for 30 to 120 seconds and cooling to 32 “C to 36° C., add vegetable almond fermentation starter in an amount of 1:0.005 to 1:0.01 based on the weight of synbiotics almond milk, and secondary fermentation may be carried out at a temperature of 34°° C. to 42” C for 8 to 12 hours.

### Effects of the Invention

According to the present invention, it is possible to provide a manufacturing method of vegetable lactic acid bacteria fermented almond milk rich in taste and nutrients in the fermentation process of vegetable almond milk by blending mixed lactic acid bacteria strains to realize the rich aroma compound of cheese in the fermentation process of vegetable almond milk, unlike milk fermented milk, controlling the fermentation process of the mixed strain to realize a rich taste, and using its metabolites.

### BRIEF DESCRIPTION OF THE DRAWINGS

FIG. 1 is a flow chart of a manufacturing method of vegetable lactic acid bacteria fermented almond milk according to an exemplary embodiment of the present invention.

FIG. 2 is growth chart of the vegetable mixed strain according to an exemplary embodiment of the present invention.

### Detailed Description of the Embodiments

The terminology used herein will be described briefly, and the present invention will be described in detail.

The terminology used herein is defined in consideration of the function of corresponding components used in the present invention and may be varied according to users, operator's intention or practices. In addition, an arbitrary defined terminology may be used in a specific case and will be described in detail in a corresponding description paragraph. Therefore, the terminology used herein is for the purpose of describing particular embodiments only and is not intended to be limiting of the invention.

Throughout the specification, unless explicitly described to the contrary, the words “include” and “comprise” and variations such as “includes” or “including” and “comprises” or “comprising,” will be understood to imply the inclusion of stated elements but not the exclusion of any other elements. In addition, terms such as “part,” “module,” etc., which are described in the specification, mean a unit that processes at least one function or operation, and may be implemented as hardware or software, or a combination thereof.

In the following detailed description, only certain exemplary embodiments of the present invention have been shown and described, simply by way of illustration so that those skilled in the art can easily work the present invention. However, the described embodiments may be modified in various different ways, all without departing from the spirit or scope of the present invention. And in order to explicitly explain the present invention in the drawings, parts irrelevant to the description are omitted, and like reference numerals are designated like parts throughout the specification.

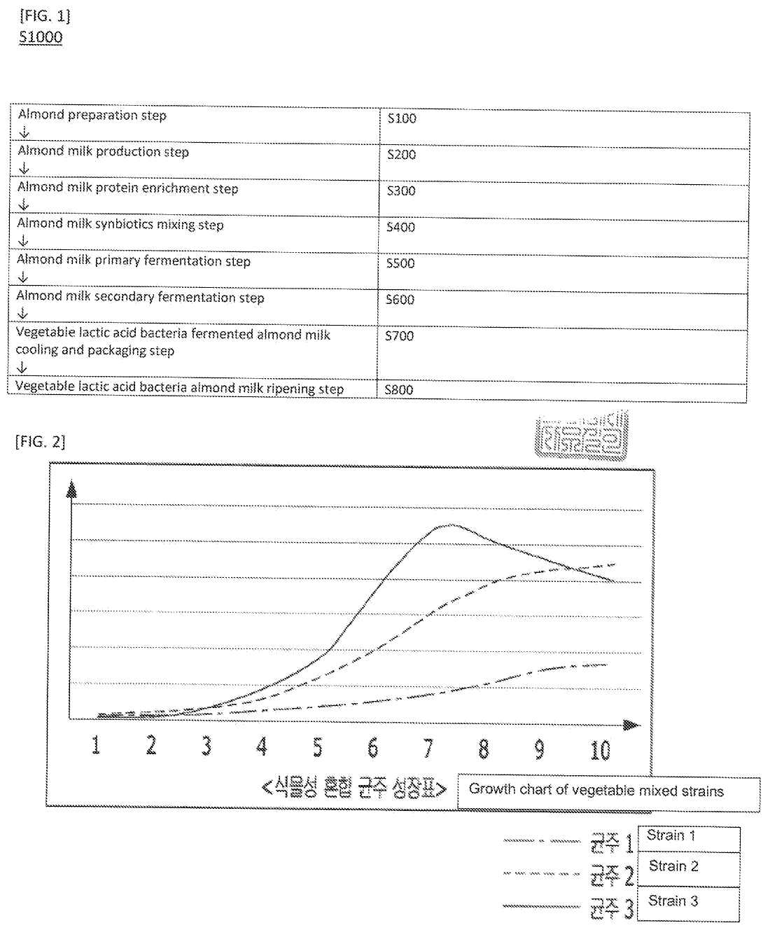

FIG. 1 is a flow chart of a manufacturing method of vegetable lactic acid bacteria fermented almond milk according to an exemplary embodiment of the present invention, and FIG. 2 is a growth chart of the vegetable mixture strain according to an exemplary embodiment of the present invention.

Referring to FIG. 1, manufacturing method of vegetable lactic acid bacteria fermented almond milk (S1000) may include at least one of almond preparation step ($100), almond milk production step (S200), almond milk protein enrichment step (S300), almond milk synbiotics mixing step (S400), almond milk primary fermentation step (S500), almond milk secondary fermentation step (S600), vegetable lactic acid bacteria fermented almond milk cooling and packaging step (S700) and vegetable lactic acid bacteria fermented almond milk ripening step (S800).

The almond preparation step (S100) is a process of screening and washing almonds to manufacture the almond milk and then preparing a hull through a soaking process in which after washing the almonds to remove foreign substances from the almond hull and performing a soaking for 6 to 24 hours on the almonds from which the foreign substances are removed, the hulls of the soaked almonds can be removed through churning.

In the almond milk production step (S200), almond milk can be prepared by extracting almonds prepared from the almond preparation step (S100). More specifically, in the almond milk production step (S200), the almonds obtained in the almond preparation step (S100) are extracted by a juicer to obtain almond milk, at this time, it is advisable to extract at low temperature to prevent rancidity and deterioration of almonds and it is advisable to minimize the fat content by extracting it with a high-moisture juice extraction method as it may coagulate with solids such as protein when almond fat is extracted, causing precipitation or causing rancidification and rancidity.

In the almond milk protein enrichment step (S300), almond milk enriched in protein can be obtained by adding almond protein to almond milk. At this time, almond protein may be added to almond milk at a ratio of 1:0.05 to 1:0.15 based on the weight of almond milk.

In the almond milk synbiotics mixing step (S400), synbiotics may be mixed with the protein-enriched almond milk almond milk provided from the almond milk protein enrichment step (S300) in order to activate the growth of vegetable mixed lactic acid bacteria strains. At this time, glucose may be added to almond milk at a ratio of 1:0.005 to 1:0.015 based on the weight of almond milk, and oligosaccharide may be added at a ratio of 1:0.002 to 1:0.025 based on the weight of almond milk.

In the almond milk primary fermentation step (S500), lactic acid bacteria can be cultured by inoculating vegetable mixed lactic acid bacteria strains into synbiotics almond milk provided from the almond milk synbiotics mixing step (S400) and performing primary fermentation. The almond milk primary fermentation step (S500) is a process of primary fermentation by inoculating the synbiotics almond milk obtained in the almond milk synbiotics mixing step (S400) with vegetable mixed lactic acid bacteria strains derived from kimchi, and at this time, as for vegetable lactic acid bacteria strains, 3 types of mixed lactic acid bacteria strains (hereinafter referred to as kimchi-derived vegetable mixed lactic acid bacteria strains) can be selected and blended with to implement the Aroma Compound of cheese, unlike milk fermented milk, in the fermentation process of vegetable almond milk. These kimchi-derived vegetable mixed lactic acid bacteria strains may include Leuconostoc Citreum, Leuconostoc Kimchi, and Lactic acid bacteria brevis. At this time, it is advisable to inoculate (inject) the kimchi-derived vegetable mixed lactic acid bacteria strain at a ratio of 1:00025 to 1:0.001 based on the weight of the synbiotics almond milk.

Wherein, kimchi-derived vegetable mixed lactic acid bacteria strains can be prepared by mixing Leuconostoc Citreum at a ratio of 1:0.25 to 0.55 with respect to the total ratio of vegetable mixed lactic acid bacteria strain, mixing Leuconostoc Kimchi at a ratio of 1:0.25 to 0.45 with respect to the total ratio of vegetable mixed lactic acid bacteria strain, and Lactic acid bacteria brevis at a ratio of 1:0.25 to 0.42 with respect to the total ratio of vegetable mixed lactic acid bacteria strain. Since in the case of a single strain, the production of fermentation odor (acidity) is fast, so it is involved in the initial culture, but the growth cycle is short, while in the case of another single strain, the fermentation cycle is long and the flavor of Aroma Compound is rich, but the initial growth is slow, in this exemplary embodiment, in order to control the fermentation process and realize the rich taste of vegetable lactic acid bacteria fermented almond milk to be finally manufactured, three types of lactic acid bacteria strains (Leuconostoc Citreum, Leuconostoc Kimchi and Lactic acid bacteria brevis) can be selected, mixed at a constant mixing ratio, and inoculated (injected) into synbiotics almond milk.

At this time, since kimchi-derived vegetable mixed lactic acid bacteria strains have a slower initial fermentation rate than general lactic acid bacteria, which may cause secondary contamination and/or insufficient securing of fermentation products, in order to improve this problem, it is advisable to shorten the culture time and at the same time to secure a moderate amount of Aroma Compound by strengthening the input concentration of the initial lactic acid bacteria by about 10 to 50 times compared to the general lactic acid bacteria input.

Meanwhile, in the almond milk lactic acid bacteria primary fermentation step (S500), sterilize synbiotics almond milk at 84 “C to 86” C for 30 to 120 seconds before mixing it with kimchi-derived vegetable mixed lactic acid bacteria strains, inoculate it with a vegetable mixed lactic acid bacteria strain after cooling to 32 “C to 36° C., and synbiotics almond milk inoculated with a vegetable mixed lactic acid bacteria strain may be primary fermented at a temperature of 32° C. to 40” C for 12 to 18 hours.

In the almond milk secondary fermentation step (S600), secondary fermentation can be performed by adding a vegetable almond fermentation starter to the primary fermented synbiotics almond milk provided through the primary almond milk lactic acid bacteria cultivation step (S500). At this time, the synbiotics almond milk is sterilized in a fermentation tank at a temperature of 84° C. to 86° C. for 30 to 120 seconds, cooled to 32 “C to 36” C, and add the vegetable almond fermentation starter at a ratio of 1:0.005 to 1:0.01 based on the weight of synbiotics almond milk, and is subjected to secondary fermentation at a temperature of 34° C. to 42° C. for 8 to 12 hours.

In the vegetable lactic acid bacteria fermented almond milk cooling and packaging step ($700), a rapid cooling process below 8° C. is performed in order to prevent post-cultivation of vegetable lactic acid bacteria fermented almond milk provided from the almond milk lactic acid bacteria secondary fermentation step (S700), the process of preventing the incorporation of foreign substances and removing carbides is performed using a 50 to 100 mesh bag or SUS filter when transporting rapidly cooled vegetable lactic acid bacteria fermented almond, the packaging process is performed after removing the iron foreign matter using a magnetic rod of 10,000 gauss or more, and weight inspection and X-ray inspection of the packaged vegetable lactic acid bacteria fermented almond milk may be performed.

In the vegetable lactic acid bacteria fermented almond milk ripening step (S800), taste and flavor of the vegetable lactic acid bacteria fermented almond milk to be finally manufactured can be formed by post-aging the packaged vegetable lactic acid bacteria fermented almond milk provided from the vegetable lactic acid bacteria fermented almond milk cooling and packaging step (S700) between 0° C. and 8° C. for 12 to 24 hours. The vegetable lactic acid bacteria fermented almond milk prepared in this way is rich in Aroma Compound compared to existing vegetable fermented milk, so it is possible to consume it alone or use it to ferment vegetable cheese.

According to this exemplary embodiment, 100% fermented vegetable almond milk produced through process in which after extracting and preparing almonds rich in minerals, dietary fiber and protein to prepare almond milk, synbiotics ingredients that help the growth of lactic acid bacteria are added, cultivate a mixed strain of vegetable lactic acid bacteria derived from kimchi as a starter culture, and the cultured starter culture is added to almond milk, and then fermented, cooled, packaged, and then post-aged, can be manufactured.

In the fermentation process of vegetable almond milk, unlike milk fermented milk, in order to realize the rich Aroma Compound of cheese, it is possible to control the fermentation process and realize the rich taste of the final fermented almond milk by selecting and blending three mixed lactic acid bacteria strains instead of a single strain.

While this invention has been described in connection with what is practically considered to be exemplary embodiments for manufacturing method of vegetable lactic acid bacteria fermented almond milk according to the present invention, it is to be understood that the invention is not limited to the disclosed embodiments, but, on the contrary, is intended to cover various modifications and equivalent arrangements by anyone skilled in the art without departing from the gist of the present invention included within the spirit and scope of the appended claims.

### *Description of Symbols*

S1000: Manufacturing method of vegetable lactic acid bacteria fermented almond milk $100: Almond preparation step
S200: Almond milk production step
S300: Almond milk protein enrichment step
S400: Almond milk synbiotics mixing step
S500: Almond milk primary fermentation step
S600; Almond milk secondary fermentation step
S700: Vegetable lactic acid bacteria fermented almond milk cooling and packaging step
S800: Vegetable lactic acid bacteria fermented almond milk ripening step

What is claimed is:

1. A manufacturing method of vegetable lactic acid bacteria fermented almond milk comprising:
an almond milk protein enrichment step of adding almond protein to almond milk;
an almond milk synbiotics mixing step of mixing the synbiotics with the protein-enriched almond milk provided from the almond milk protein enrichment step;
an almond milk lactic acid bacteria primary fermentation step of primary fermentation by inoculating vegetable mixed lactic acid bacteria strain into the synbiotics almond milk provided from the almond milk synbiotics mixing step; and
an almond milk lactic acid bacteria secondary fermentation step in which vegetable almond fermentation starter is added to the primary fermented synbiotics almond milk provided from the primary cultivation step of the almond milk lactic acid bacteria and secondary fermentation is performed.

2. The manufacturing method of vegetable lactic acid bacteria fermented almond milk of claim 1, further comprising:
a almond preparation step, wherein the almonds are washed to remove foreign substances from the almond hull prior to the almond milk protein enrichment step, and after performing a soaking for 6 to 24 hours on the almonds from which the foreign substances are removed outer hull of the soaked almonds is removed through churning; and
an almond milk production step of producing almond milk by extracting almonds prepared from the almond preparation step.

3. The manufacturing method of vegetable lactic acid bacteria fermented almond milk of claim 1, further comprising:
a vegetable lactic acid bacteria fermented almond milk cooling and packaging step wherein a rapid cooling process below 8° C. is performed in order to prevent post-cultivation of vegetable lactic acid bacteria fermented almond milk provided from the almond milk lactic acid bacteria secondary fermentation step, process of preventing the inclusion of foreign substances and removing carbides is performed using a 50 to 100 mesh bag or SUS filter when transporting rapidly cooled vegetable lactic acid bacteria fermented almond for packaging, the packaging process is performed after removing the iron foreign matter using a magnetic rod of 10,000 gauss or more, and weight inspection and X-ray inspection of the packaged vegetable lactic acid bacteria fermented almond milk is performed.

4. The manufacturing method of vegetable lactic acid bacteria fermented almond milk of claim 3,
further comprising a vegetable lactic acid bacteria fermented almond milk ripening step
wherein the packaged vegetable lactic acid bacteria fermented almond milk provided from the vegetable lactic acid bacteria fermented almond milk cooling and packaging step is aged between 0° C. and 8° C. for 12 to 24 hours.

5. The manufacturing method of vegetable lactic acid bacteria fermented almond milk of claim 1,
wherein the almond milk protein enrichment step is adding almond protein to almond milk at a ratio of 1:0.05 to 1:0.15 based on the weight of almond milk.

6. The manufacturing method of vegetable lactic acid bacteria fermented almond milk of claim 1,
wherein the almond milk synbiotics mixing step is adding glucose to almond milk at a ratio of 1:0.005 to 1:0.015 based on the weight of almond milk and adding oligosaccharides at a ratio of 1:0.002 to 1:0.025 based on the weight of almond milk.

7. The manufacturing method of vegetable lactic acid bacteria fermented almond milk of claim 1,
wherein the almond milk lactic acid bacteria primary fermentation step is mixing synbiotics almond milk with vegetable mixed lactic acid bacteria strains including Leuconostoc Citreum, Leuconostoc Kimchi and Lactic acid bacteria brevis, inoculating vegetable mixed lactic acid bacteria strain at a ratio of 1:00025 to 1:0.001 based on the weight of synbiotics almond milk.

8. The manufacturing method of vegetable lactic acid bacteria fermented almond milk of claim 7,
wherein the almond milk lactic acid bacteria primary fermentation step is preparing the vegetable mixed lactic acid bacteria strain by mixing Leuconostoc Citreum at a ratio of 1:0.25 to 0.55 to the total ratio of vegetable mixed lactic acid bacteria strain, mixing Leuconostoc Kimchi at a ratio of 1:0.25 to 0.45 to the total ratio of vegetable mixed lactic acid bacteria strain, and mixing Lactic acid bacteria brevis at a ratio of 1:0.25 to 0.42 to the total ratio of vegetable mixed lactic acid bacteria strain.

9. The manufacturing method of vegetable lactic acid bacteria fermented almond milk of claim 7,
wherein the almond milk lactic acid bacteria primary fermentation step is sterilizing synbiotics almond milk at 84° C. to 86° C. for 30 to 120 seconds prior to mixing with vegetable mixed lactic acid bacteria strain, inoculating a vegetable mixed lactic acid bacteria strain after cooling to 32° C. to 36° C., and
performing primary fermentation of synbiotics almond milk inoculated with vegetable mixed lactic acid bacteria strain at a temperature of 32° C. to 40° C. for 12 to 18 hours.

10. The manufacturing method of vegetable lactic acid bacteria fermented almond milk of claim 1,
wherein the almond milk lactic acid bacteria secondary fermentation step. iş sterilizing synbiotics almond milk at 84° C. to 86° C. for 30 to 120 seconds and cooling to 32*° C. to 36° C., adding vegetable almond fermentation starter at a ratio of 1:0.005 to 1:0.01 based on the weight of synbiotics almond milk, and performing secondary fermentation at a temperature of 34° C. to 42° C. for 8 to 12 hours.
